(19) United States
(12) Patent Application Publication
(10) Pub. No.: US 2011/0218814 A1
(43) Pub. Date: Sep. 8, 2011

(54) METHOD AND SYSTEM FOR ASSESSING A PATIENT'S CONDITION

(75) Inventor: Paul B. Coats, Whitefish, MT (US)

(73) Assignee: Applied Health Services, Inc., Kalispell, MT (US)

(21) Appl. No.: 13/041,188

(22) Filed: Mar. 4, 2011

Related U.S. Application Data
(60) Provisional application No. 61/311,217, filed on Mar. 5, 2010.

(51) Int. Cl. G06Q 50/00

(52) U.S. Cl. 705/2

(57) ABSTRACT

The present disclosure is directed to a method and system that include performing an examination protocol for a patient's condition structured for use in an asynchronous telemedicine environment. The performing includes storing information about the patient's condition in an electronic examination storage medium, providing remote access to the electronic examination storage medium over a computer network, and transmitting notice of changes to the information over the computer network. Performing the examination protocol further includes recording a series of patient movements using a range of motion measurement device having a plurality of reference points for visualizing outward indications of the patient's condition.

### BACKGROUND

1. Technical Field

The present disclosure relates to examination and diagnosis protocols in the medical field and, more particularly, to a method and system of assessing a patient's condition by providing audio and visual records of the patient's condition to a plurality of clinicians for collaborative diagnosis and treatment.

2. Description of the Related Art

Currently, a patient with an injury or undiagnosed pain may visit multiple doctors before their condition is diagnosed. At each doctor, the patient fills out medical history forms, answers questions about the condition, and has a clinician perform a physical examination to learn about the condition. Each of these visits is at least thirty minutes not including the commute and scheduling time. This is expensive and time consuming for the patient and for the doctors, especially for patients living in rural areas.

The various doctors often duplicate efforts to diagnose and treat patients. This makes the healthcare system inefficient and expensive. Several attempts have been made to address this problem of inefficiency. For Example, U.S. Pat. No. 7,408,439 to Wang et al. provides a single interface to many disparate forms of medical data, which is accessible over a network or direct connection during a medical procedure. For example, an operating room control system includes an input device, a display device, and a controller that is coupled to the input device and the display device. The controller receives user inputs, transmits a command to a server located outside of the operating room to retrieve medical data, receives the medical data from the server, and displays the medical data on the display device. Medical data can be captured by the controller using, for example, a camera and a video/image capture board, keyboard, and microphone during surgery or examination of the patient. The captured medical data can be stored on one or more remote servers as part of the patient records.

U.S. Patent Application No. 2005/0049898 to Hirakawa describes a telemedicine system where a consultation may be conducted by e-mail. A patient schedules an appointment using a medical reservation system on the internet, sees a doctor live by using a video conference system, pays electronically, and receives medicine by an electronic prescription system. This enables long-distance medical examinations and home-medicine programs. This application involves all remote communications and does not include face-to-face evaluations.

U.S. Patent Application No. 2006/0173708 to Vining et al. is directed to a system and method for providing health care that includes establishing a predetermined patient population grouped by geographic regions where the patient population has access to a traveling healthcare professional that travels to the patients. The healthcare professional evaluates and examines the patient using a plurality of technologies with, audio/video/data transfer and communications systems, medical devices, and other vital measurement devices. The healthcare professional communicates in real-time with a physician located at a physicians' center to assess and consult about the patient.

The physician at the physicians' center conducts a virtual house call by evaluating information directly collected by the healthcare professional that is face-to-face with the patient and instructing the healthcare professional during the physician's examination. The healthcare professional is under the delegation of the physician and treats the patient under the physician's instructions. The method also allows for the assessment, treatment, diagnosis, and sharing of medical information and care to be provided to the patient by the healthcare professional at the patient's location, and to other authorized healthcare professionals a the physician's center.

U.S. Patent Application No. 2003/0229521 to Fuchs et al. provides a method and device for the administration of medical patient data with a centralized or decentralized patient medical file. The patient medical file contains all previous examinations with data representing when the examination was conducted and the findings. A check-in of the patient into the device is implemented before a new examination by the physician. The check-in ensues upon indication of the initial suspicion and in advance of the planned examinations. A comparison device determines if there are no relevant or previous examinations present in a specific preceding time span and only then enables the documentation of the new examination. In addition, invoicing of the new examination is possible only in conjunction with documentation of the examination and its results in the patient medical file.

Other systems have been developed to assist in evaluation of a patient's complaint. For example, U.S. Pat. No. 7,519,210 to Hirsch et al. presents a method of assessing localized shape and temperatures of the human body. The method is provided for objectively quantifying joints having arthritis for purposes of assessment, diagnosis, and treatment. The objective measurements utilize known imaging modalities including 3D scanning, thermal imaging, visible and near-infrared imaging, and two-dimensional imaging to quantify swelling, heat distribution, erythema, and range of motion. The objective measurements can be combined in various ways to assess the extent of the disease and can be used to adjust treatment protocols. For example, a video-based system can track a patient's wrist movements to calculate joint angle and can average a range of motion in real time.

U.S. Patent Application No. 2007/0083384 to Geslak et al. is directed to a method and system for posture awareness training. The system captures a plurality of digital images of a given person for providing posture analysis. The images may be displayed in a screen along with interactive vertical lines (vertical axis) and horizontal lines (top, bottom, and middle). An orthogonal gridline may be scaled by converting a physical mesh size provided by a user to a pixel mesh size and then overlaid on the image to assist in posture analysis. The system retains a historical record for the given person so that posture and training effectiveness may be tracked over time. In an alternative embodiment, an orthogonal grid made of a vinyl material is attached to a wall to photograph the patient standing in front of the grid. The grid may be used to provide a reference when measuring posture alignment. However, relevant gridlines are blocked by the client's body, and the physical difference between the location of the client's body and the location of the grid can lead to difficulty in measuring and other problems with perspective.

Various other patents, such as U.S. Pat. No. 3,885,090 to Rosenbaum and U.S. Pat. No. 4,150,825 to Wilson use grid patterns to assist in viewing a person's movements.

### BRIEF SUMMARY

The present disclosure is directed to a method for capturing, storing, transmitting, displaying, and updating assessments, examinations, and evaluations of a patient's condition via electronic media for use by patients, clinicians, health care providers, and system administrators. In accordance with one aspect of the present disclosure, the method includes, without limitation, performing an examination protocol for a patient's condition structured for use in an asynchronous telemedicine environment. The performing of the examination includes storing information about the patient's condition in an electronic examination storage medium, providing remote access to the electronic examination storage medium over a computer network, and transmitting notice of changes to the information over the computer network. Performing the examination protocol further includes recording a series of patient movements using a range of motion measurement device having a plurality of reference points for visualizing outward indications of the patient's condition.

In another embodiment, a method and system is provided for documenting medical examinations, integrating clinical information, compiling a patient record, securely storing this data, and providing access to the data on the web so that a plurality of remote expert clinicians can collaboratively review and treat a patient's condition. The system allows the clinicians to provide analysis, record comments and treatment plans, and also be compensated for their recommendations on the individual patient examination compilations. Ideally, the system is an asynchronous and synchronous telemedicine system when fully implemented, provides a new model for health care delivery, research, and education.

In accordance with a further aspect of the present disclosure, the system includes providing recordings of a series of patient movements in association with a range of motion measurement device that has a plurality of reference points for visualizing outward indications of the patient's condition, such as a patient's range of motion, reflex responses, and strength. The system synergistically employs the latest in information technology to make it possible for an injured or infirm patient to have their examination compilation reviewed by multiple clinicians without having to go through multiple examinations.

For example, the system provides for consolidating a patient's diagnosis and treatment into an electronic system by first performing an initial live consultation to prepare written patient information and audio-visual documentation of a series of movements in front of an adjustable measurement device, and then providing the documentation to a plurality of remote clinicians to collaboratively diagnose and treat the patient. In addition, a range of motion measurement device having a plurality of reference lines positioned on a transparent material that is adjustable to account for patients of different heights assists the clinicians' review of the patient's condition. In addition, the system provides for integrating the patient's medical records, including tests and radiological images ordered at the initial consultation, and automatic physician billing into the system.

Use of this system can improve health care delivery system efficiency, save patient and third party payer time and money, reduce the likelihood of missed diagnosis, and establish a standardized database for research and educational functions.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings.

FIG. 1 is a flowchart of features in a system for collaborative treatment and diagnosis of a patient condition formed in accordance with the present disclosure;

FIG. 2 is a table of various levels of external interaction with the system of FIG. 1;

FIG. 3 is a simplified flowchart of a clinician's interaction with the system of FIG. 1;

FIG. 4 is a flowchart of a potential patient's interaction with the system of FIG. 1;

FIGS. 5-8B are flowcharts of participant interaction with the system of FIG. 1;

FIG. 9 is a isometric view of a range of motion measurement device; and

FIGS. 10A and 10B are illustrations clothing configured to aid in video a patient's movements in the range of motion measurement device of FIG. 9.

### DETAILED DESCRIPTION

In the following description, certain specific details are set forth in order to provide a thorough understanding of various embodiments of the disclosure. However, one skilled in the art will understand that the disclosure may be practiced without these specific details. In some instances, well-known structures associated with diagnosing and treating patients have not been described in detail to avoid obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. In the drawings, identical reference numbers identify similar features or elements. The size and relative positions of features in the drawings are not necessarily drawn to scale

In one embodiment of the present disclosure, a system and method provide an interactive system that is accessible to a plurality of clinicians for collaborative diagnosis and treatment of a patient. Ideally, the patient is referred by a primary care provider, a third party administrator, such as a workman's compensation agent, or from an emergency room, and the system is structured to provide for in person, telephonic, and on-line referrals.

In order to diagnose the patient's condition and determine what treatments to provide, an examination protocol or initial consultation is performed by an examiner at an examination center. The examination protocol starts the process of addressing and assessing the cause of the patient's condition and providing recommendations for treatments to deal with the patient's condition. Because the plurality of clinicians may have overlapping aspects of an examination that they would generally conduct, the system combines the needs of the plurality of clinicians into an examination protocol that records visual indications or signs of the patient's condition. By combining a plurality of examinations of different clinicians into an examination protocol, the patient can reduce the number of medical evaluation visits.

As an example, if the patient has a spine related condition, the plurality of clinicians who may be involved include neurosurgeons, orthopedic surgeons, pain management specialists, chiropractors, and physical therapists. Some or all of these clinicians may be involved in the treatment and diagnosis of the patient. For example, the pain management specialists and the physical therapists may work with the patient prior to surgery and after the surgery is performed by the orthopedist.

The present disclosure is directed to a method and system for assessing a patient's condition by providing audio and visual records of the patient's condition to the plurality of remote clinicians for collaborative diagnosis and treatment. Many patients exhibit specific visually observable outward signs and symptoms of untreated conditions, such as spinal or neurological issues, that are difficult to convey in a written description. The system is applicable in fields of medicine that diagnose patients by observing physical movements. Also, multiple physicians can asynchronously access and comment on an electronic examination storage medium.

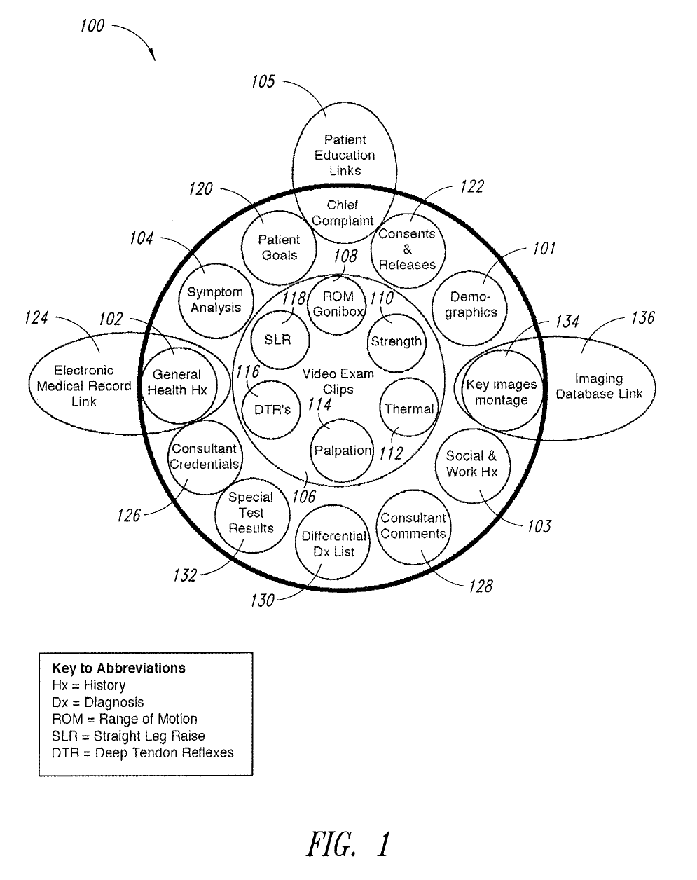

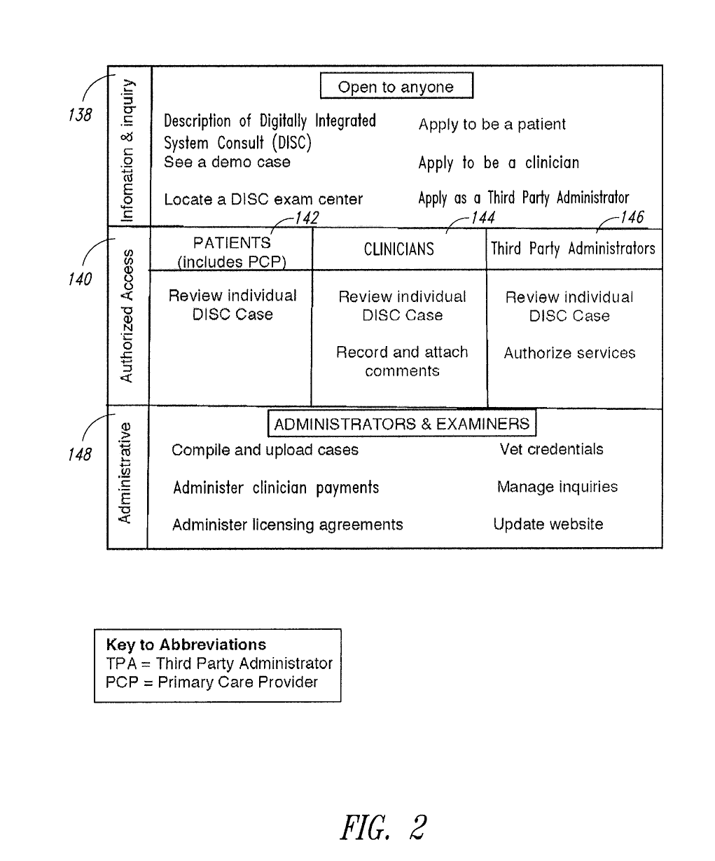

FIG. 1 is a simplified diagram of various components provided in a system 100 formed in accordance with one aspect of the present disclosure. Various parties are provided with access to the system to participate in evaluation of the patient's condition, including the patient, an examiner, the clinicians, and third party administrators, to name a few. Preferably the system is implemented in electronic form to facilitate communication and access to the records, as well as creation, maintenance, and updating of patient records. These records can include, without limitation, prior history, current conditions, examinations, evaluations, recommendations, implemented treatment protocols, follow-up examinations and evaluations and associated recommendations, financial records, and patient input.

An examination protocol is performed by an examiner who is trained to collect data that clearly presents information about the patient's condition, see Chief Complaint 105. The examiner may ask the patient demographic questions and specifics about the injury or pain, see Demographics 101, General Health History 102, Social and Work History 103, and Symptom Analysis 104. In one embodiment, the examiner enters the patient demographic information via a data entry device into a computer or other electronic device configured to compile and store the information into an electronic memory of the system 100. A user interface may be generated, such as on a screen display or printed on paper, to provide the examiner with guidelines regarding standard demographic information, such as name, date of birth, and address. A computer program may generate the user interface and auto-populate the system 100 with digital data collected by the examiner. The user interface may also include a display of other dialog boxes for entry of other information, such as specifics about the injury or pain.

All of the data and information collected about the patient is stored in a patient examination compilation in an electronic memory or storage medium that is accessible by others over a computer network. The plurality of clinicians can access and add to the patient examination compilation from remote locations to collaboratively diagnose and recommend treatment plans for the patient.

Once the examiner has saved or stored the patient examination compilation in the electronic storage medium, the clinicians can review and analyze the patient on their own time. A clinician remotely logs on to the system, reviews the patient examination compilation, and within a short amount of time, such as 15 to 30 minutes, provides feedback, comments, or recommendations, to the other clinicians about the patient's condition. This significantly decreases the time previously used to have multiple parties review a patient's condition over the course of several hours, days, or even weeks.

The clinician's comments and recommendations are used to quickly triage the patient's condition so that the patient can next visit the most appropriate treating clinician, such as a surgeon or physical therapist. The result is more efficient use of clinician time and faster delivery of patients to treatment. Additionally, the 24/7 online availability of the patient examination compilations means that consulting clinicians can review cases anywhere and anytime that they can access the computer network. Hence, consultations can occur with minimal support staff, office space or standard office-hours scheduling constraints.

In the figures, the term ‘DISC’ describes a Digitally Integrated System Consult, which is an alternative name for the system 100 and its components. DISC is synonymous with the system described herein. The DISC system decreases the travel time for patients and clinicians, which is beneficial in remote geographic areas, where currently, in places like Montana, a rural patient often has to drive hundreds of miles to get expert consultation. Health service providers, who would otherwise have to travel to remote outreach clinics, can provide similar service from their home or office. The improved health care service efficiency allows managers and clinicians to save money by precisely targeting the clinician's skill-set to the patients that truly need the particular service. For example, money and time spent on having a neurosurgeon evaluate and review a non-neurosurgical patient condition represents a wasteful use of the surgeon's time and the patient's money. With this system, the neurosurgeon's review saves the surgeon's time so that his skills can be best utilized performing surgeries. The system also saves the consumer the cost of unnecessary consultations.

In accordance with a further aspect of the present disclosure, the system 100 includes performing an examination protocol to acquire written, audio, and visual records and documentation of the patient's condition. The examiner visually records with a video camera the patient executing a series of movements that are selected based on the type of injury or pain in order to provide the audio and visual records. The recorded videos may incorporate a plurality of devices to better visually indicated features of the patient's condition. For example, if the patient is having lower back pain, the examiner will video the patient performing a range-of-motion test with a variety of fixed references points that provide visual indications of the patient's condition. The examiner may also perform and video a reflex test, a straight leg raise, and the patient rising from a chair and ambulating. As shown in FIG. 1, the examination protocol may include various video clips 106 that show such things as Range of Motion 108, Strength 110, Thermal imaging 112, Palpation examinations 114, Deep Tendon Reflex's (DTR) 116, and Straight Leg Raises (SLR) 118.

A plurality of videos of the patient performing a series of movements in front of a measurement device, such as the range of motion measurement device described below with respect to FIG. 9. The videos are provided to the clinicians to observe these movements and look for specific signs and symptoms to assist in the diagnosis and treatment of the patient. Different series of movements are selected and videoed based on the types of injuries. For example, for a patient with a shoulder injury the video records a variety of arm movements in front of the measurement device in order to illustrate useful information to the consulting clinicians.

The examiner may also video the patient's goals or a patient interview, see Patient Goals 120. The patient may also give consent or release liability orally or sign a release while being recorded on the video camera, see Consents & Releases 122. The audio, video, and written documentation is integrated into the system with the patient information and stored in the electronic examination storage medium.

Once the examination protocol is complete, the examiner stores all the patient information and examination protocol documents in the electronic examination storage medium. Alternatively, the patient information can be stored automatically in real-time. A notification is then sent manually or automatically to the plurality of participating clinicians to indicate a change in the status of the electronic examination storage medium.

The system 100 is a remotely accessible interactive interface that allows each clinician to view the videos and read the written patient intake information. The system 100 provides an interface or link to the patient's electronic medical records 124 so the reviewing clinician can see prior history and results of tests that may have been ordered from the initial evaluation.

Each clinician can login from any location that has access to a computer network, such as an intranet or the worldwide network of computers, commonly referred to as the internet. In order to gain access to the system 100, the clinician registers and provides credential information, see Clinician Credentials 126. This credential information can include personal identification such as a driver's license, passport, medical license, with or without a photograph, or credential information provided earlier by the system 100 via an authorization process.

The system 100 also provides clinicians with a method of communicating with each other regarding hypothesis of diagnosis, tests to confirm or further clarify the diagnosis, or to order specific treatments, see Clinician Comments 128, Differential Diagnosis 130, and Special Test Results 132. For example, the orthopedist may request that the patient meet with the physical therapist instead of a surgical consultation. The clinician may also order blood work or a follow up evaluation to record different movements for further evaluation of the patient's condition.

Depending on the type of injury or pain, the patient may have a series of radiological images, such as MRIs, CT Scans, X-Rays, and ultra sounds, which can be assembled into a Key Images Montage 134. The system 100 also provides an interface 136 to these radiological images so the clinician can review the video of the patient's movements in conjunction with the radiological imagery.

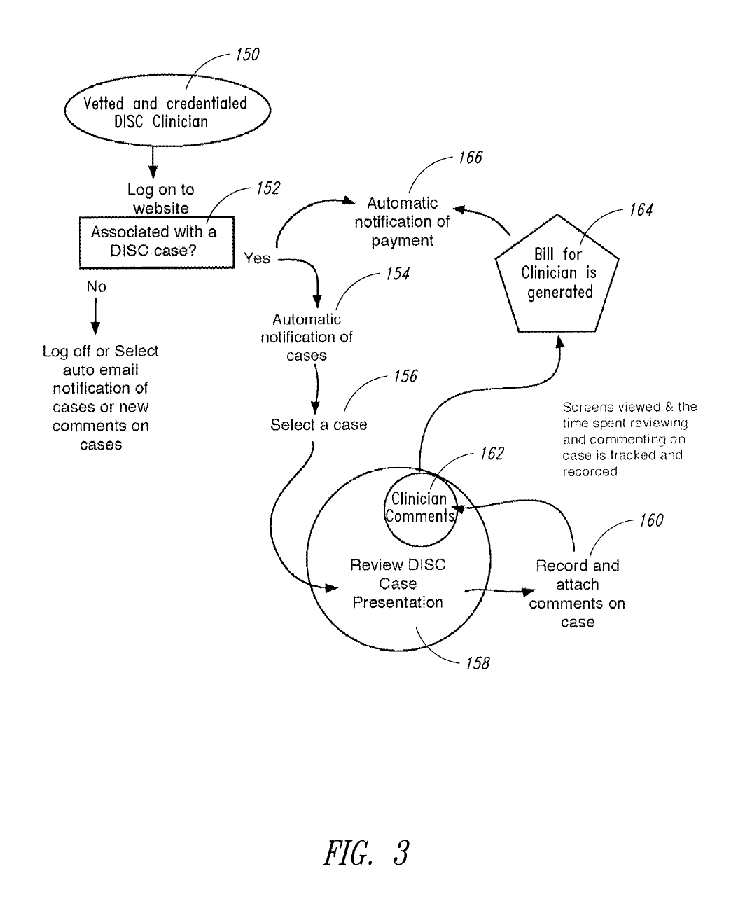

FIG. 2 is a table of levels of access to the data generated and stored in conjunction with the system 100. There are various levels of privacy provided by the system 100. For example, an Information and Inquiry portion 138 of the system 100 is open to everyone, such as a home page of a website. The Information and Inquiry portion 138 includes a description of the system, applications for patients, clinicians, researchers, educators, and third party administrators, such as insurance companies or workman's compensation organizations, locations of examination centers, and an example examination compilation showing how the systems works.

Once patients, clinicians, and third party administrators apply, they receive authorization to access the system 100. An Authorized Access portion 140 is secure and password protected to protect patient confidentiality. Each participating party is provided access to different aspects of the electronic patient storage medium. The participating parties may include patient, clinicians, consultants, third party administrators, researchers, educators, and students. For example, patients 142, including individuals and primary care providers, can review specific individual patient records and examinations protocols. The clinicians 144 can review individual patient examination storage medium for patients on which they are participating clinicians. The clinicians 144 can also record and attach comments to the patient examination storage medium.

Third party administrators 146 are provided with access to view portions of the patient examination storage medium to determine if they should authorize services. The third party administrators may be insurance companies, workman's compensation adjustors, or other claims adjustors that could use the system to rapidly evaluate and authorize treatments or compensations. The rapid access to medical documentation facilitates better informed decisions about service authorization, reduces consultation costs, and accelerates case processing.

For worker's compensation cases, the timesaving generated relative to waiting for expert consultation and input translates into significant money and time savings for the adjuster and the patient. Additionally, the claims adjusters and case managers can directly view details of a patient's condition, which allows more prudent and timely decision making in regards to testing and treatment authorization.

There is another level of access to the system, which is an administrative portion 148 where an examiner or other person with administrative access can compile and upload patient information, administer clinician payments, administer licensing agreements to use the system, review credentials of the clinicians, process applications, and manage inquiries.

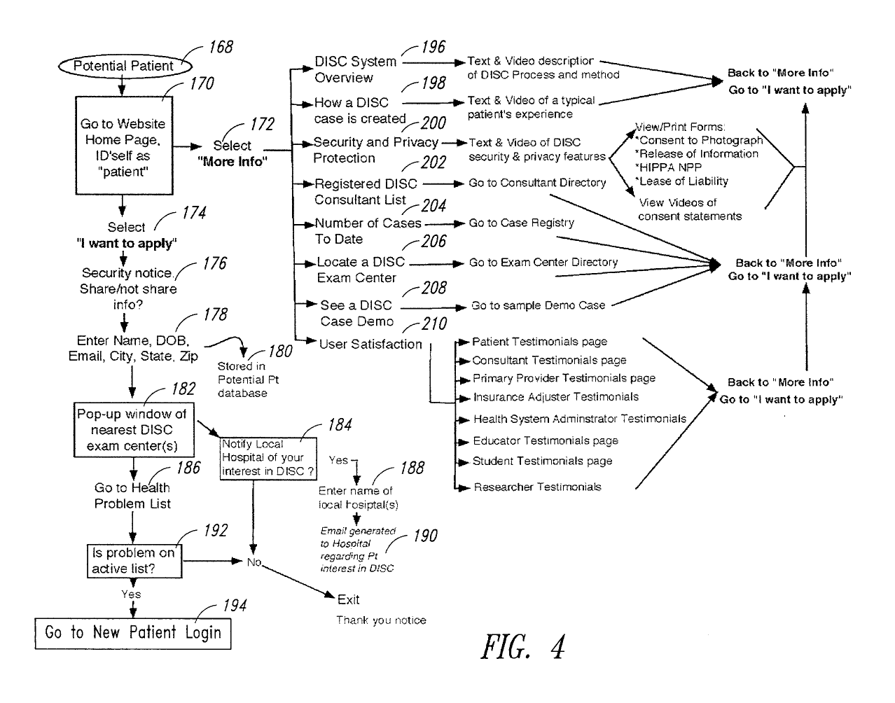

FIG. 3 is a flowchart of how a clinician may interact with the system 100. The clinician's review begins at step 150, where an authorized clinician (i.e., a vetted and credentialed clinician) has been provided access through a secure login. Once the clinician is logged in, the system 100 determines, at step 152, if the clinician is already associated with an examination compilation, i.e. if the clinician is currently working with a patient. If the clinician is working with a patient, the system 100 allows the clinician to select, at step 154, to view notifications. At step 156, the clinician can select to view one of the patient's files, which will link the clinician to a patient examination information storage medium.

At step 158, the clinician can review all of the examination protocol data, including the audio, video, and written documentation of the patient's condition, which are stored in the patient examination storage medium. After reviewing the examination protocol at step 158, the clinician may record and attach comments at step 160. The comments may be recorded audio, video, or written comments. Once the clinician attaches the comments, the comments are stored in the patient examination storage medium, at step 162, such that when others access the patient examination storage medium they can view these comments.

The system 100 constantly tracks when a clinician has logged into the system and separately tracks how much time the clinician spends reviewing an individual's patient examination storage medium. At step 164, an automatic bill is generated that depends on the time the clinician took to review and comment on the patient's condition. At step 166, the system may automatically notify the clinician or a third party administrator of a payment made towards the bill.

At step 152, if the clinician is not associated with a patient yet, the clinician may choose to log off, select automatic email notification, or provide comments on a new patient examination compilation.

FIG. 4 is a flowchart of options available to a potential patient 168 who is interested in participating or being evaluated using the system 100. At 170, the potential patient 168 visits the home page and identifies themselves as a “patient.” The potential patient 168 have several options, including reading more information, “Select ‘More Info’” 172 or “Select ‘I want to Apply’” 174. If “I want to Apply” 174 is selected, the patient is asked to acknowledge a security notice and prompted to share name and address information at “Security notice. Share/not share info?” 176.

At 178, the potential patient 168 enters their name, date of birth, email, and address information. This is stored by the system 100 at 180, which can later be incorporated into a patient examination compilation if the potential patient elects to participate in the system 100.

At 182, a list of the closest facilities is provided to the potential patient 168. The potential patient 168 is prompted regarding their interest in the system and is provided with a way to notify a local hospital or their primary care provider of their interest in participating in the system at 184. The system may automatically determine the closest hospitals to the potential patient's zip code or the system may prompt the potential patient to enter the hospital's name at 188. The system may automatically generate an email or inquiry to the hospital at 190.

Alternatively, the potential patient 168 may review a list of health problems and conditions that may be addressed by participating in the system, at 186. The potential patient 168 determines if their condition is treatable with the system at 192. If the condition is treatable, the patient is redirected to the patient login page 194 where they can apply to participate. If the condition is not treatable, the potential patient 168 is informed of such and redirected.

If the patient selected “More Info” 172, a plurality of options are presented to the patient including, but not limited to, an overview of the system 196, how a patient examination compilation is created 198, security and privacy protections 200, registered clinicians or consultants 202, the number of examination compilations completed or prepared to date 204, locate an examination center 206, view an examination demo 208, and user satisfaction 210.

The system overview 196 and how a patient examination compilation 198 is created are illustrated with text and video descriptions of the system 100. The security and privacy protections 200 may be illustrated with text and video descriptions. If the potential patient 168 is interested, the patient may view and print consent and release forms, view HIPPA compliance standards, or view other related security forms.

Viewing the registered clinicians or consultants 202 means the system provides a directory of participants in the system. The number of examination compilations completed or prepared to date 204 may result in a redacted list of patient examination protocols performed. Selecting to view the location of an examination center 206 provides a directory of exam centers. Selecting the examination demo 208 links the potential patient to a sample examination protocol. The user satisfaction option 210 provides the potential patient with testimonials from patients, primary care providers, insurance adjustment agents, consultants, health system administrators, educators, students, and researchers. Once each of the options under “More Info” 172 is viewed, the potential patient 168 may be redirected to the “More Info” 172 menu or to the “I want to Apply” 174 menu.

The system will also include information for potential clinicians, third party administrators, or other health care providers to learn about patient examination compilations and collaborative diagnosis.

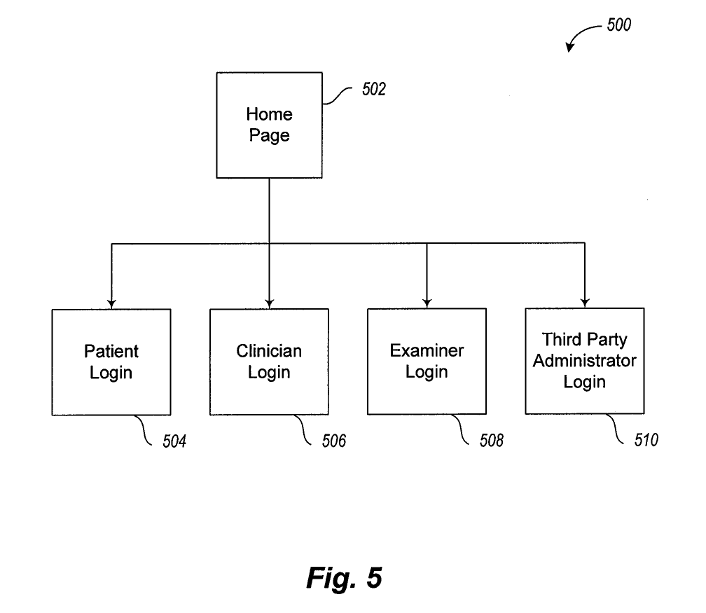

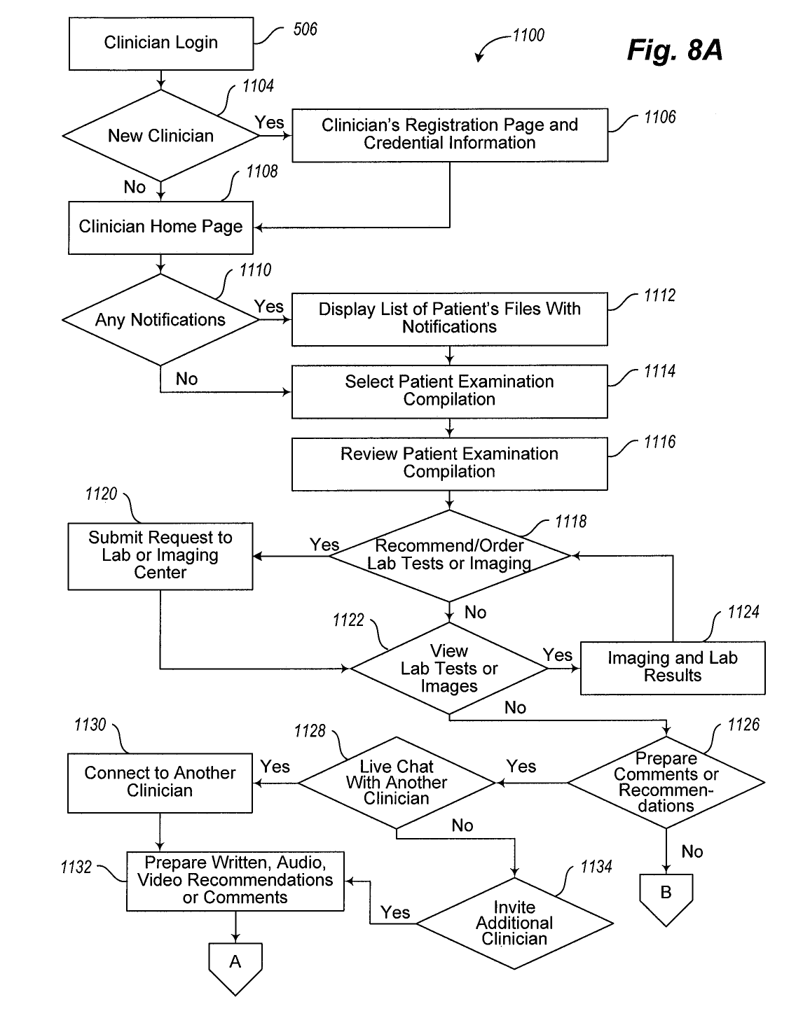

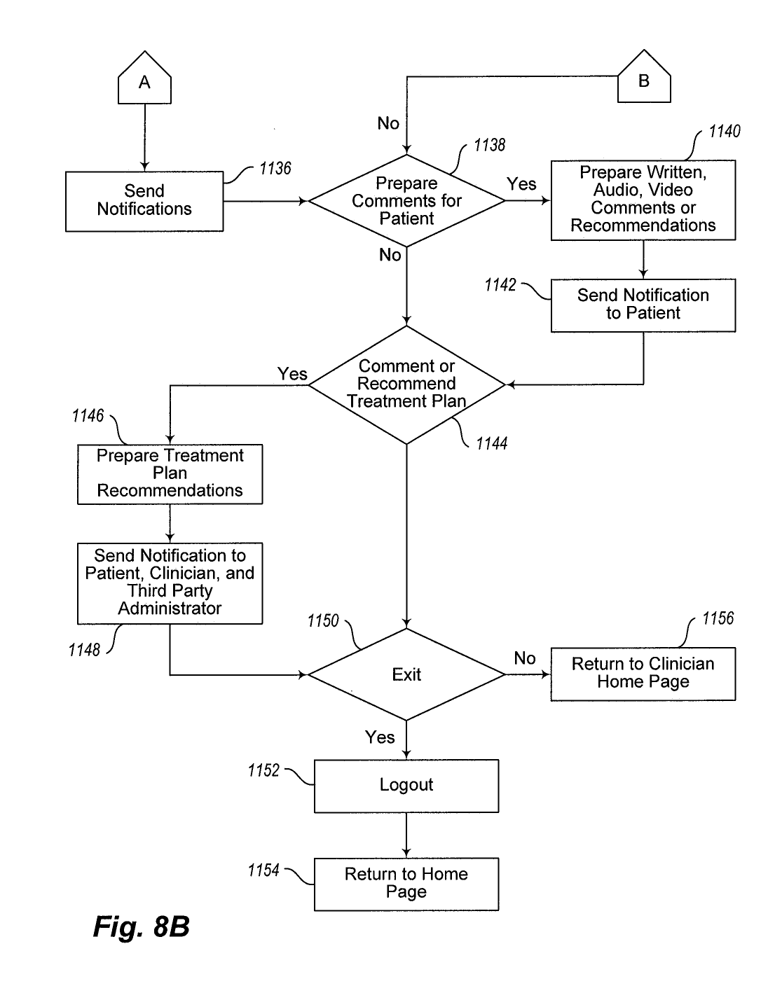

FIGS. 5-7C and 11A-11B are flowcharts of how various parties can access and interact with the system. FIGS. 8-10 are structures and devices to be used in conjunction with the system.

FIG. 5 is a simplified flowchart 500 of the system, which can be accessed through a home page 502 provided through a computer network, such as the internet or an intranet. The home page 502 includes login links or dialog boxes for each participant. For example, a patient login 504, a clinician login 506, an examiner login 508, and a third party administrator login 510. The home page 502 may also include information for potential participants. For example, as described with respect to FIG. 4, the home page 502 may include information for the potential patient 168 and for a potential clinician, a potential third party administrator, or other interested parties.

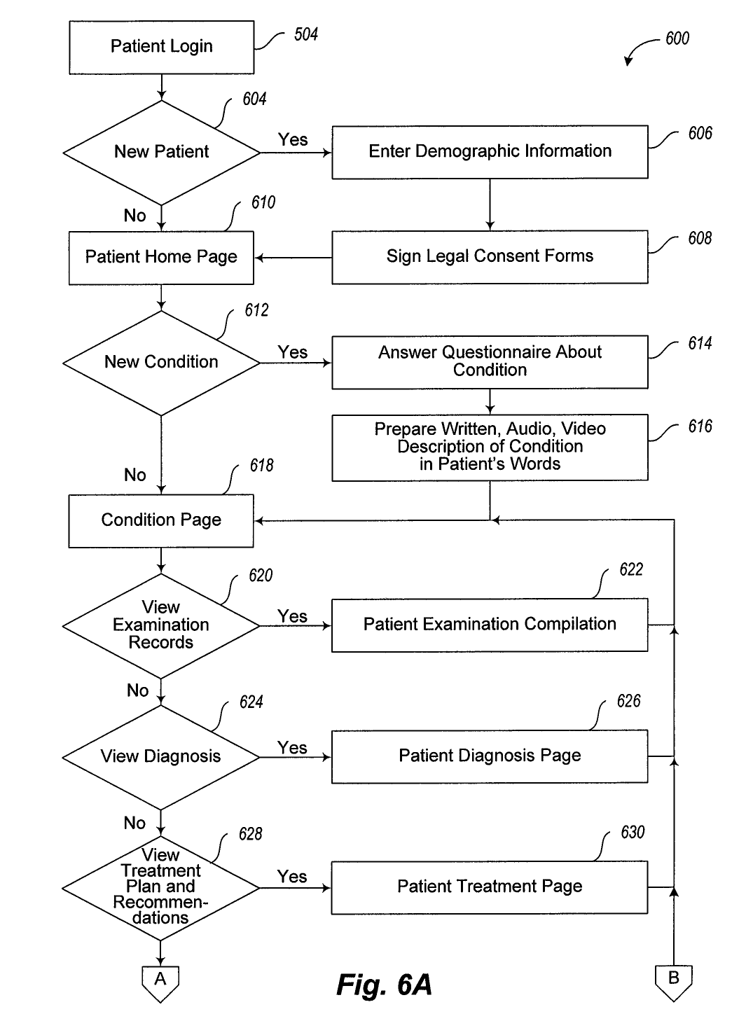

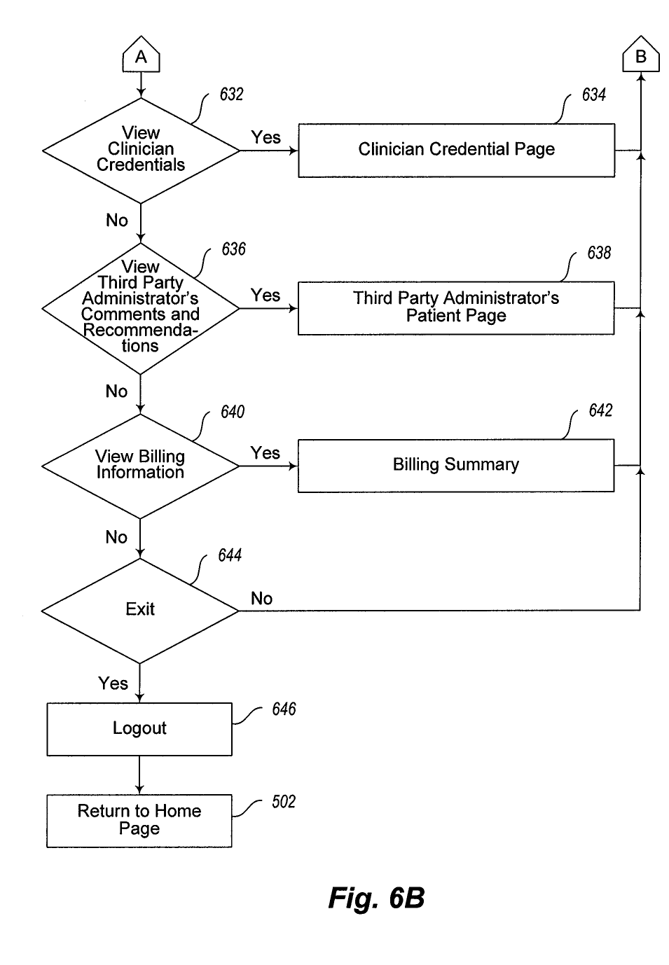

FIGS. 6A and 6B are flowcharts of one embodiment of a patient's interaction with the system, starting from a patient login 504. Patients will use the system to access a range of clinicians, potentially lower costs in time savings and travel savings. The collaborative diagnosis and treatment plans from a plurality of clinicians can provide the patient with better information, the patients receive multiple opinions, which can decrease a chance for misdiagnosis and provides the patient with an option to participate in their own treatment.

At 604, the patient is prompted to login if they are an existing patient or if they are a new patient they are prompted to enter demographic information at 606. New patients may also be required to provide some form of authorization in order to enter their information and otherwise have access to the system. For example, the authorization can be provided by one with administrative access or a care provider, such as a clinician. The patient's demographic information may be an electronic form or a paper form that can be scanned and saved in the patient examination compilation. In one embodiment, the patient enters the demographic information prior to visiting an examiner. Alternatively, the examiner can work with the patient to fill out the demographic information during the examination. The system may auto-populate a questionnaire or patent intake information when opening a new system for a new patient or new examination compilation.

At 608, the new patient is prompted to submit signed legal consent or release forms. The legal consent may be an electronic signature form, a paper form that can be scanned and saved, or a videoed oral consent. The legal consent is stored as a part of the electronic examination compilation, which is stored on an electronic memory or storage medium. Once the consent has been documented, the patient is directed to a Patient Home Page 610.

If the patient is an existing patient, they are directed to the Patient Home Page 610. The Patient Home Page 610 is a central repository of information where the patient can review aspects of their condition, comments from clinicians, recommendations for treatment plans, authorizations from third party administrators, and education information about their condition. All of this information may be stored as part of the patient examination compilation. Alternatively, some of the information may be stored as a link in the patient examination compilation to direct the patient to a specific website. For example, if there is a physical therapy training video that a clinician recommends the patient view, the clinician may include a link instead of directly attaching and saving the video.

From the Patient Home Page 610, the patient selects an existing condition or begins the process of examining a new condition, see New Condition 612. If the patient is reviewing an existing condition, the patient is directed to a Condition Page 618. The Condition Page 618 includes audio, video, and written documentation of their condition that is collected by the examiner and saved in the patient examination compilation. The Condition Page 618 may also include information entered by a third party administrator or by the patient.

If this is a new condition 612, the patient answers a questionnaire about the condition at 614. The questionnaire may be electronic or on paper and may be completed on the patient's own time or with the examiner. At 616, the patient prepares a written, audio, or video description of the condition in the patient's words. This may be performed with the examiner or prior to the examination. Once the questionnaire and description of the condition are prepared, the patient is directed to the condition page 618.

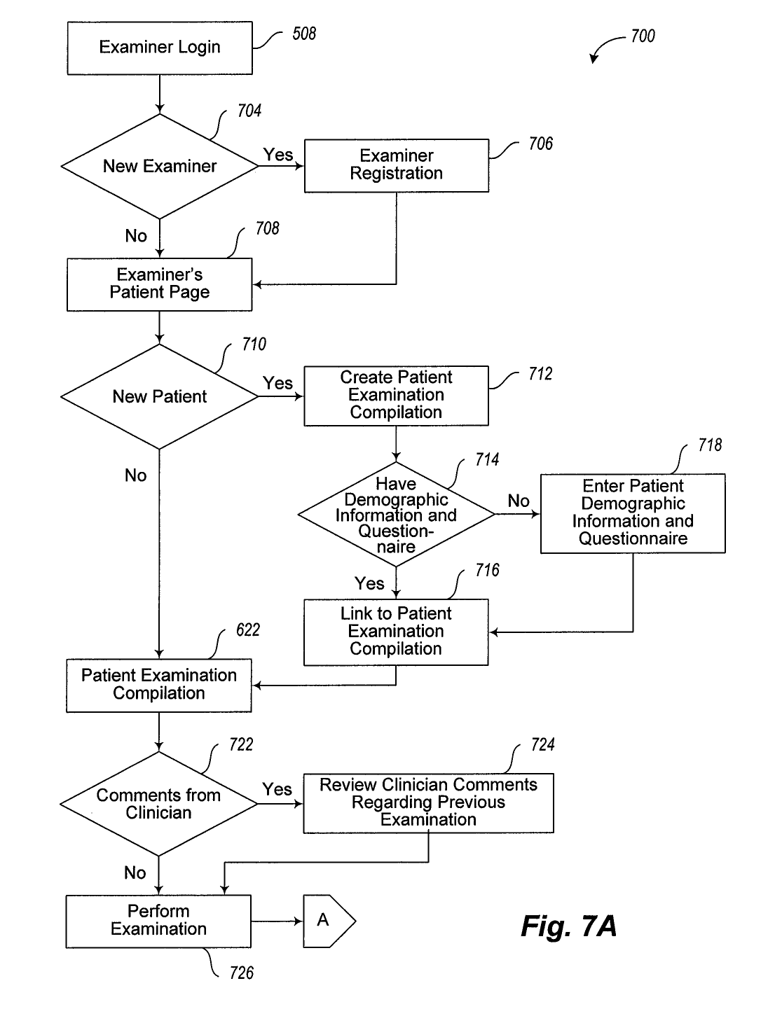

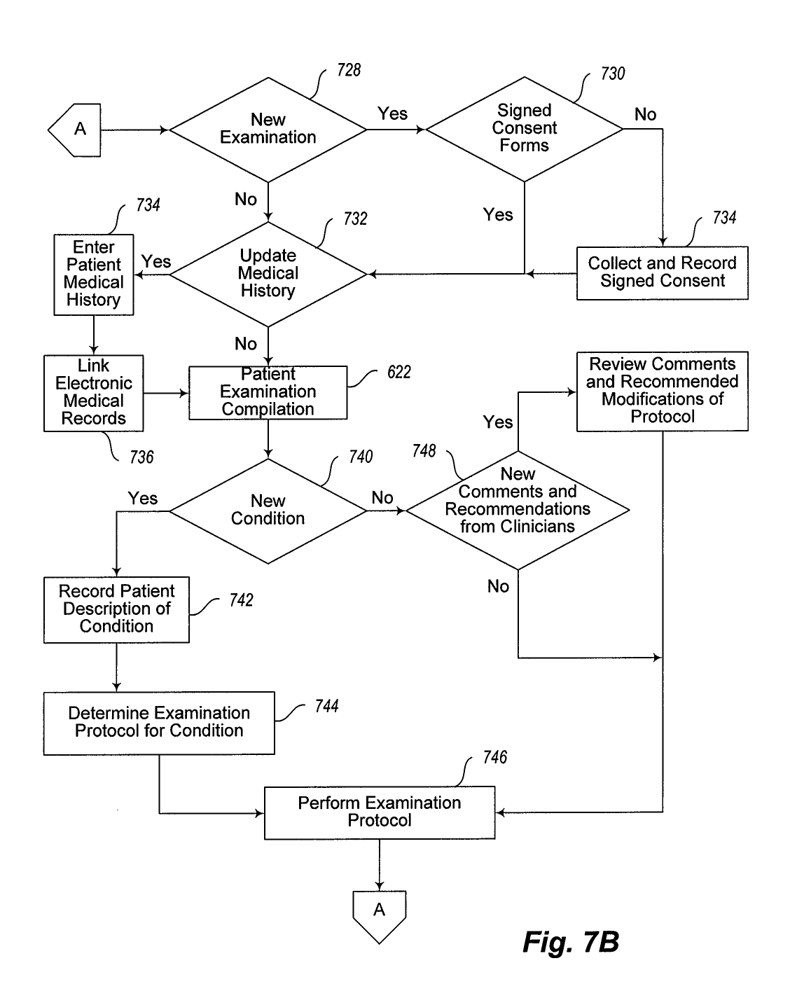

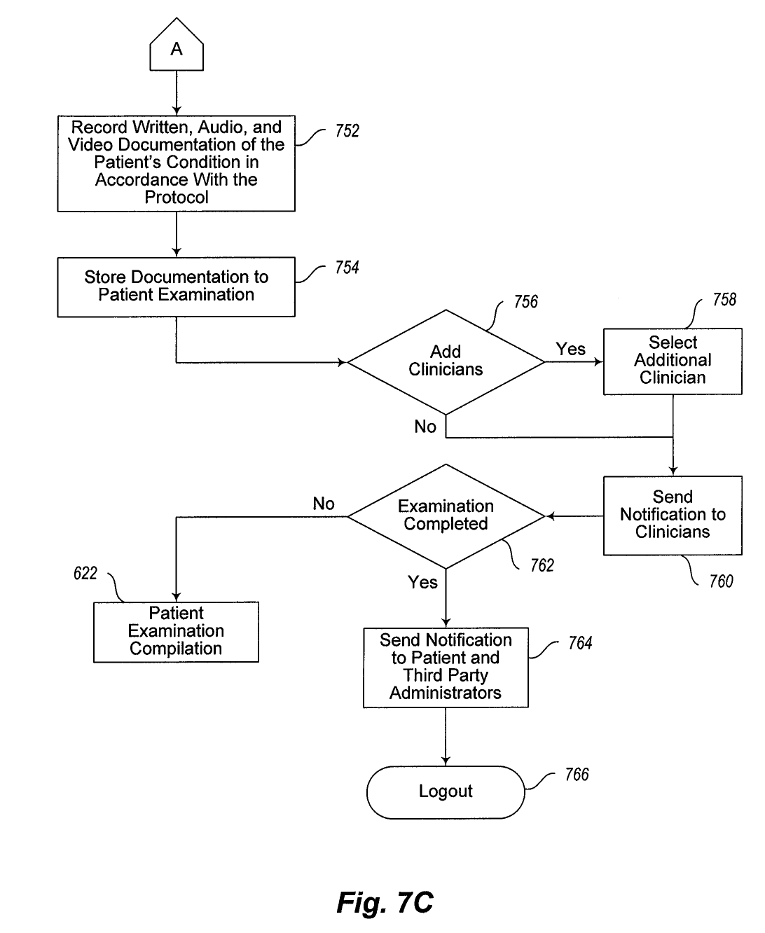

From the condition page, the patient may review a number of documents or information. The order in which the patient may review these documents will be dictated by the patient on a visit by visit basis. An example of a series of options that the patient may chose is illustrated in FIG. 6A. The patient may select to view examination records of their condition at 620, which directs the patient to the Patient Examination Compilation 622. A more detailed description of the Patient Examination Compilation is provided below with respect to FIGS. 7A-7C.

The patient may select to view a diagnosis of their condition at 624, which directs the patient to a Patient Diagnosis Page 626. In one embodiment, the patient receives the diagnosis in person and then the patient examination compilation is updated with the diagnosis. In addition, the diagnosis may be updated based on tests, imaging, or results of physical therapy. The patient may alternatively view a treatment plan and recommendations at 628. A Patient Treatment Page 630 may include written, audio, and video recommendations and descriptions for treating the condition.

Once the patient has finished viewing any of these condition page options, the patient is returned to the condition page 618. Other options available for the patient to view include viewing clinician credentials 632, viewing third party administrator comments and recommendations 636, and viewing billing information 640. Viewing the clinician credentials 632 will take the patient to a Clinician Credential Page 634. Viewing the third party administrator comments and recommendations 636 will take the patient to the Third Party Administrator Page 638. Viewing the billing information 640 will take the patient to the Billing Summary 642.

If the patient is finished reviewing the condition page 618 stored in the patient examination compilation, the patient may chose to exit 644 and logout 646. Once logged out, the patient is returned to the home page at 502.

FIGS. 7A-7C are a flowchart 700 for how an examiner may interact with the system. The examiners are trained or certified examiners, which could be a licensed healthcare professional or trained technician. The examiner may conduct the examination alone or with the help of a videographer or other staff.

At 508, the examiner logs into the system. If a new examiner is accessing the system, the examiner is directed from a New Examiner inquiry 704 to an Examiner Registration page 706. Once the examiner is appropriately registered, An Examiner's Patient Page 708 is provided.

If the examiner is examining a new patient, the examiner is directed from a New Patient inquiry 710 to create a new patent examination compilation at 712. As mentioned above with respect to FIG. 1, the examiner documents the patient's medical history, social and work history, comments about the patient's condition, and patient goals, to name a few. Based on this information the examiner determines an examination protocol to use for documenting the patient's condition. The examination protocols are standardized so that the patient examination compilations are consistent and reliable documentations of the patient's condition. However, the examination protocols may also be customizable to address unique conditions or a plurality of chief complaints of the patient. There may also be standard formatting for patient medical history to streamline the review of patient examination compilations.

At 714 the examiner determines if the patient has not entered demographic information prior to the examination. If the patient has not entered this information, the examiner may work with the patient to enter the demographic information and answer a questionnaire at 718. The examiner may ask the questions orally and record the responses or the patient may have returned a completed paper form that can be scanned and saved in the patient examination compilation. The examiner may have the patient sign and prepare consent and release forms with the demographic information and the questionnaire or may wait until a later time in the examination, such as at Signed Consent Forms inquiry 730 below.

During the examination, the examiner stores or otherwise uploads documentation to the patient examination compilation, such as at step 716. Once the patient demographic information is stored, the examiner is directed to the patient examination compilation 622, which is the same information that is used to present examination data to the patient in the flowchart of FIGS. 6A and 6B.

The examiner determines, at 722, whether any comments have been prepared and attached by the clinicians. These comments may be added before an examination, such as from a referring primary care provider, or these comments may be for a follow up examination. For example, at 724, one of the clinicians may have reviewed the patient examination compilation and provided recommendations regarding what types of tests to perform to provide more specific information about the condition.

If there are no comments, the examiner begins performing the examination, at 726. If this is a new examination rather than continuing a previous examination, the examiner determines if consent forms have been signed and submitted via the Signed Consent Forms inquiry 730. If the consent and release forms have not been signed, the examiner collects and records the consent at 734. As mentioned above, the consent may be written or videoed.

At 732, the examiner determines if there are updates to the patient's medical history as related to the patient's condition. The examiner collects information about the patient's present and past medical conditions. At 734, the examiner updates the patient's medical history. The system provides the option of linking the patient's electronic medical record, at 736, to the patient examination compilation.

Once all of the preliminary information is collected, the examiner begins discussing the patient's condition. At 740, the examiner determines if the condition is a new condition. If the condition is a new condition, the examiner works with the patient to record a description of the condition at 742. There may be audio, video, and written components of the record of the patient's condition, from the patient's perspective. Other tools, such as heart monitors and electrocardiograms may be used to document the patient's vital signs. Then the examiner determines an examination protocol to perform on the patient at 744.

If the condition is not a new condition, the examiner determines if there are any comments or recommendations from participating clinicians at 748. One of the clinicians may provide comments or recommendations regarding modifications to the protocol to better capture information about the condition.

Next, the examiner performs the examination protocol 746. In FIG. 7B, the examiner records written, audio, and video documentation of the patient's condition in accordance with a selected examination protocol at 752. In one embodiment of the system, a patient is seeking treatment for a back injury. The patient was referred by his primary care provider to set up an initial examination with an examiner. The patient may be referred by the emergency room, their primary care physician, or through other avenues. The examiner may enter the information through a computer or other electronic device. Audio and video capturing equipment, including without limitation, microphones and cameras (both still and video cameras), may be connected to the computer to automatically link the audio and video records to the system.

The examination protocols are designed for specific injuries and may include a range of motion examination, a reflex examination, an axial loading test, Spreling's maneuvers (twists and movements of the neck), straight leg raise, FABER's movements (flexion, abduction, and external rotation), focused motor and strength examination, focused coordination examination (weakness in arms and legs, or toe raises), video of a patient standing up and ambulating. The examination protocols may also include patient vital signs and electrocardiograms.

A range of motion measurement device, such as the measurement device 800 in FIG. 9, may be used to enhance the quality of the information captured by the video of the patient moving. The range of motion measurement device 800 will be described in more detail below.

The examination protocol may also capture the amount of force the patient is able to exert while performing specific movements. The patient may use a measurement device attached to the specific body part under observation to display how many pounds or kilograms of force the patient is able to exert when challenged to do so. A variety of dynamometers may be used to measure and display the pounds or kilograms of weight associated with grip strength, push-pull, and lifting capacities. For example, a Baseline Push-Pull Dynamometer System, a Grip strength dynamometer, and pinch strength dynamometers may be used. Such devices are available at http://www.isokineticsinc.com/.

Accordingly, different injuries and pain complaints may use different examination protocols for collecting and recording data to be used in the system. For example, in the evaluation of a knee disorder, a standard knee disorder protocol for the exact movements, examination techniques, and filming techniques is delineated. The examiner collecting the documentation is trained in the correct performance of these protocols.

The patient movements and reactions using these various tools are recorded so the clinicians can replay and review the patient's movements instead of relying on the examiner's written descriptions alone. For example, if the patient has a lower back injury, the patient may have a limited range of motion when bending forward towards their toes. The clinician will be able to see at what point in the bend the patient grimaces in pain or shifts their weight in response to pain.

In another embodiment, a thermal scanning device records variation in the patient's skin temperature may be included in the system. This is useful in documenting increased levels of heat which in turn can help identify areas of localized inflammation. The examination protocols may use other specialized tools such as microscopic cameras or various scopes.

In another embodiment, a method for providing color highlighting over the image of the patient to delineate areas of sensory alteration is provided. For example, the color green would indicate decreased temperature sensation, red for vibration, blue for pinprick. If a patient was experiencing decreased temperature sensation over the lateral aspect of her left foot, a picture of the patient with the lateral left foot highlighted in green would appear as a part of the system. In addition, the system may include a “burn to DVD/CD” option that allows the examination compilation to be copied onto a removable storage/play medium that the patient can view at home or with family members.

Below is a list of just some of the conditions where the system could be applied. The basic system format is utilized, with more focused protocols for each area of concern.

| Conditions: | Exam Protocol(s): |
|---|---|
| Neck disorders | Neck |
| Shoulder disorders | Neck and Shoulder |
| Elbow disorders | Shoulder and Elbow |
| Wrist disorders | Neck, Elbow and Hand |
| Thoracic disorders | Neck and Back |
| LS spine disorders | Back and Hip |
| Hip disorders | Back and Hip |
| Knee disorders | Back and Knee |
| Ankle disorders | Foot |
| Foot disorders | Foot |
| Movement disorders | Parkinson's protocol |
| Skin disorders | Dermatology protocol |
| Psychiatric disorders | Psych protocol |
| Chronic Pain disorders | Fibromyalgia protocol |

Most of the orthopedic disorders would use a protocol that documents range of motion, strength, and reflex, to name a few. The Parkinson's Protocol would include special video sequences of the patient's movements, filming of tremor activity, recording speech, samples of handwriting and spiral drawings, mental status/memory testing, balance and coordination tests. The writing tests may be performed on a tablet computer that directly records the patient's writing samples. The Dermatology Protocol could focus on detailed skin and thermal images and could include before and after allergy test images. The Psych Protocol would feature more structured interviews and tests. The Fibromyalgia Protocol would feature a more detailed and widespread palpation exam. This is just a sample listing and more condition-specific protocols may be developed.

After recording the written, audio, and video documentation of the patient's condition, the system stores the documentation to the patient examination compilation in the storage medium 754. This storage medium 754 may be memory of a computer, a database on a server, a portable memory device, such as a CD, DVD, flash drive, or any other suitable non-volatile electronic storage.

At 756, the examiner can add clinicians. A list of clinicians may be provided at 758 for the examiner to select from. Alternatively, the examiner enters in a clinician's information directly. Once the clinicians have been appropriately added, the system sends notifications to the participating clinicians at 760.

At 762, the system inquires whether the examination is completed. If the examination in not complete, the system returns the examiner to the patient examination compilation at 622. If the examination is complete, the system sends notifications to the patient and to the participating third party administrators at 764. In an alternative embodiment, the clinicians may be notified simultaneously with the patients and third party administrators instead of at an earlier stage in the process. Once the examination is complete, the examiner logs off of the system at 766.

FIGS. 8A and 8B are a flowchart of a clinician's interaction with the system once the examiner stores the patient examination compilation in the patient storage medium. At 506, the clinician logs into the system. Each clinician registers, submits credentialing, enters billing data, and pays a licensing fee to participate in the system. Administrators of the system vet the clinicians before the clinicians are granted access to the system. The plurality of clinicians that may evaluate the patient include neurosurgeons, orthopedics, chiropractors, physical therapists, and pain management, to name a few. Other areas of medicine that may utilize the system include other specialties of orthopedics, dermatology, rheumatology, neurology, neurosurgery, psychiatry, and rehabilitation medicine.

At 1104, the system inquires if the clinician is a new clinician. New clinicians register and submit credential information at 1106. Credentialed clinicians are directed to a Clinician Home Page at 1108. The system notifies the clinician of any notifications at 1110. If there are notifications from other clinicians or the examiner, the system displays a list of the clinician's patients associated with the notifications at 1112. At 1114, the clinician selects one of the patient examination compilations to review.

In one embodiment, the clinicians act as consultants that provide comments about the patient's condition and provide recommendations about treatment. The clinicians recommend a specific physician for the patient to see after viewing the patient examination compilation. In this embodiment, the patient will work with a treating physician or their primary care physician on the treatment, such as surgery. The system assists physicians in diagnosing and treating difficult or ambiguous cases beyond the expertise of a referring clinician.

Once the clinician has reviewed the patient examination compilation at 1116, the clinician may recommend or order additional lab tests, imaging, or further examination videos at 1118. At 1120, the clinician submits the request for lab tests or imaging. Imaging requests may include MRIs, CTScans, X-rays, or other specialized images. At 1122, the clinicians can chose to view lab tests and images. At 1124, the system links the clinician to the imaging and lab test results.

The clinician can provide comments or recommendations to other participating clinicians at 1126 to collaboratively evaluate the patient's condition based on the video, audio, and written documentation stored in the patient examination compilation. The system provides the clinicians with a live chat opportunity at 1128. One clinician requests a live chat with another clinician by sending a request. At 1130, the clinicians establish a connection over the computer network to discuss the patient's condition.

At 1134, the clinician can invite an additional clinician to review the patient's examination compilation. For example, a specialized clinician may be invited to provide additional insight into the patient's condition. At 1132, the clinician requesting participation prepares written, audio, and video comments for the additional clinician to review. Alternatively, the clinicians can prepare comments during or after a live chat. The comments are added to the patient examination compilation so that subsequent reviewers can evaluate the patient's condition in light of the clinician's comments.

At 1136, the system sends notifications about changes or updates in the stored record to other participating clinicians, the patient, the examiner, the third party administrator, and any other party with access to the patient examination compilation. At 1138, the clinician can provide the patient with comments and recommendations. For example, if the patient has followed a treatment plan and returned for a follow up visit, the clinician can provide feedback to the patient regarding improvements. Also, if the clinician is a physical therapist, the clinician may provide more specific information about how to perform certain treatments at home. At 1140, the clinician prepares the written, audio, or video comments or recommendations. At 1142, the system sends a notification directly to the patient regarding the entry of new comments from the clinician.

At 1144, the clinician prepares comments or recommendations about a treatment plan. At 1146, the clinician prepares the comments and then at 1148, the system sends a notification to the other participants. These may be recommendations that the patient discusses directly with the examiner or the patient's primary care physician.

The system inquires if the clinician is finished with their review for the particular patient at 1150. If the clinician is not finished, the clinician is returned to the Clinician Home Page at 1156. If the clinician is finished, the clinician logs out at 1152 and is then returned to the Home Page of the system, at 1154.

Billing information may also be generated during the clinician's review of the system. For example, the system tracks when the clinician accesses a patient examination compilation and when the clinician indicates he is finished with the patient examination compilation. The system generates a bill for a third party provider for payment based on the time elapsed during the review.

Billing information may also be generated after the initial examination protocol. For example, when the patient is seen face to face by the system examiner who is preparing the examination compilation, the patient can be billed for a new patient examination. If the visit goes for greater than 1 hour, then a prolonged examination code is also entered. After the patient leaves and the examiner is compiling the system examination compilation, then a prolonged, non face to face visit code applies for the first hour and another code applies for each additional 30 minutes. If the codes are deemed not applicable, it is most likely that an “unlisted/unassigned” code would be employed to bill for the system online clinicians services at first.

The system can integrate billing information so that the reviewing clinicians or examiners can prepare or generate a bill simultaneously with the review or creation of the conference. The conference can track the amount of time the clinicians spends reviewing the patient's examination compilation and prepare and transmit a bill when the clinician logs out.

FIG. 9 is an embodiment of the range of motion measurement device 800 that includes a frame 802 and a plurality of moveable reference plates 804a-c. The frame 802 has a plurality of supports 806a-d, a base 808, and a ceiling 810. The plurality of supports 806 may be metal, wood, plastic, or other sturdy material. The base 808 is thin so that a patient can easily enter the measurement device 800 without having to raise their leg significantly. A background panel 812 is positioned between two of the supports 806a and 806b.

In this embodiment, there are two reference plates 804a and 804b are removeably attached to two supports 806c and 806d. The supports 806a-d are configured to receive the plates 804, which allows the measurement device to be configured for patients of various sizes with differing conditions. Another plate 804c is attached a top of the supports 806 to form the ceiling 810. This top plate may be permanently attached or removeably attached as needed.

Each plate 804 is made of a transparent material, such as plexi-glass, that includes a plurality of reference lines 814. In this embodiment, each plate includes a horizontal, a vertical, and two diagonal reference lines 814. The two diagonal reference lines 814 are angled at 45 degrees from the horizontal and vertical reference lines 814. In other embodiments, the plates 804 have various sizes and arrangements of the reference lines 814 to accommodate the different patients and conditions. Since some patients are shorter than others, adjustment to the positioning of the plates 804 will help the videographer or examiner to align the reference lines 814 with the patient prior to the patient performing the series of movements.

A patient can stand on the base 808, sit on a chair positioned in the device 800, or lie on an examination table positioned in the device 800. The video camera captures the various movements behind the fixed reference points, which provides a visual indication of the patient's range of motion. For example, if the examiner requests that the patient lift their arm, a clinician viewing the video of this arm movement can clearly see if the patient can lift their arm past their shoulder or not past the 45 degree reference line 814. For the shoulder patient, only one large plate 804 may be needed, which is positioned in line with the patient's torso. For the lower back pain patient, both of the large plates 804 may be used to see how the lower body response to movements of the upper body.

The measurement device 800 is useful to documents with video or photograph postural alignment of a patient from a frontal and lateral perspective. The patient can demonstrate cervical flexion and extension by bending at the hips while in the measurement device 800. The background panel 812 is a solid color to make the reference lines 814 more visible to the clinician reviewing the video. The clinicians can easily see what the patient's range of motion is by observing the patient with respect to the fixed reference lines 814 on the plates. The measurement device 800 assists the patient in demonstrating cervical right lateral bending and cervical left lateral bending, by performing the series of movements while facing the camera. Other patient movements that can be recorded include cervical rotation and Lumbosacral rotation, flexion, and extension.

In one embodiment for a shoulder injury evaluation, the intersection of the horizontal and vertical reference lines 814 of the top plate 804a is positioned in relation to the patient's shoulders and the vertical reference line 814 of the bottom plate 804b is positioned in relation to the patient's hips and legs. A distance between the top and bottom plates may be fixed or may be adjustable to account for patients of different heights. The plates may be overlapped when attached to the supports 806. Also, the references lines 814 may be aligned to the left or right of a center line of the plates 804 to allow for various patient sizes and shapes.

In order to perform the shoulder evaluation protocol, the examiner first collects standard historical data regarding age, height, weight, occupation, recreational pursuits, health habits, past and current health problems, and the current complaint in accordance with the system described herein. The protocol also includes collecting information regarding mechanism of injury, as well as onset, duration, quality and character of symptoms, aggravating factors, relieving factors, work up to date, attempts at treatment, and results of past treatment efforts.

The patient then stands in the measurement device 800 with the horizontal axis of the upper plate level with her shoulders, facing the camera and performing a series of specified movements, like arm raises and rotations of the head. The top plate 804c includes reference lines 814 so that a video camera positioned above the measurement device 800 can capture rotations of the patients head.

The shoulder protocol may also include a recorded palpation examination. This includes positioning the patient to stand face forward and instructing the patient to speak up about areas of tenderness as the palpation exams are performed. The examiner can comment on any areas of clicking, grinding, or popping. In addition, the examiner can film with full audio as the clavicles, the AC joints, the subacromial bursas, the bicipital grooves, and the lesser tuberosities are palpated. The patient may be turned to the affected side and palpated in the greater tuberosity. The patient may also be turned so their back is facing the camera and palpate the trapezius, scapular spines, supraspinatus muscles, and infraspinatus muscles. This sequence allows for visual and auditory localization of areas of pain to palpation.

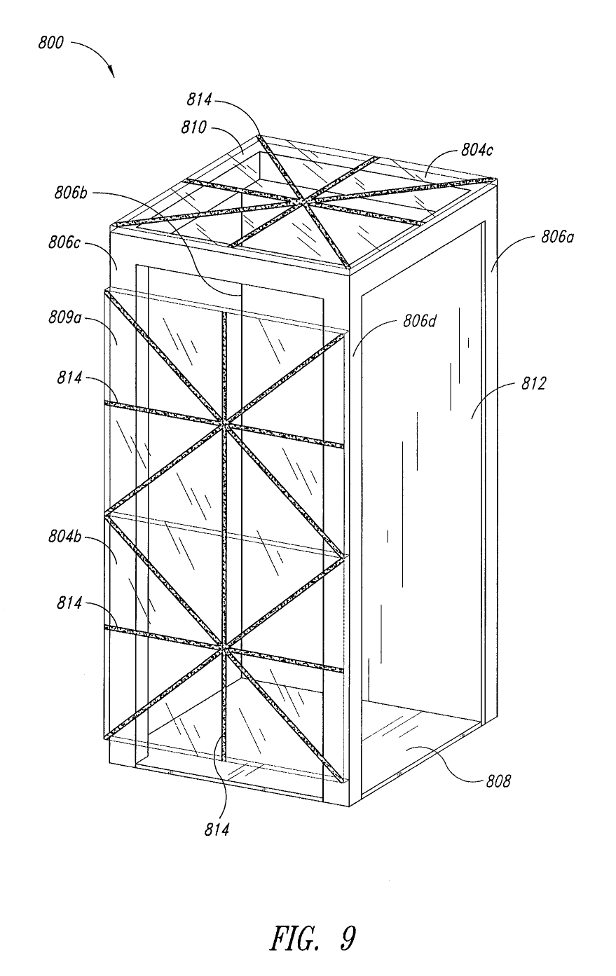

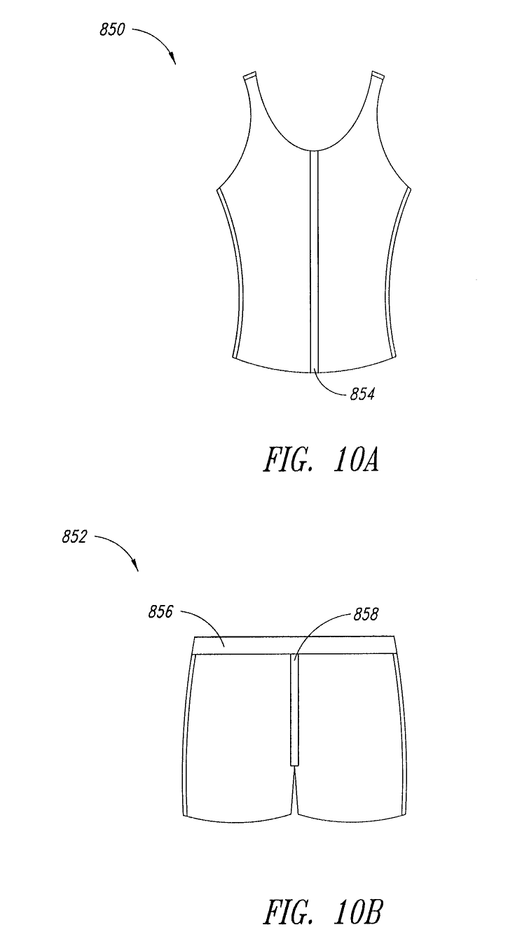

In one embodiment, the patient wears specialized clothing 850, 852 as shown in FIGS. 10A and 10B. The clothing includes a shirt 850 and pants 852 that include a plurality of visible reference lines 854, 856, and 858. The shirt may be long sleeve, short sleeve, or sleeveless as shown. Alternatively, the reference lines 854, 856, and 858 may be a reflective material or other responsive material that can be temporarily or permanently attached to the patient's clothing.

While wearing the shirt 850 or pants 852, the examiner videos the patient for a period of time through a series of movements to provide visual indications of the patient's condition. The reference lines 854, 856, and 858 on the shirt and the references lines 814 on the plates 806 allow clinicians to asynchronously visualize the patient's range of motion.

The reference lines 854, 856, and 858 may include a plurality of radio frequency identification (RFID) tags configured to communicate a patient's position with respect to a plurality of readers positioned on the supports 806 of the measurement device 800. Precise movement distances can be captured by the RFID tags and readers and can be automatically stored in the patient examination compilation. Alternatively, the RFID tags may be temporarily attached to a patient's clothing during the examination to provide automatic position reference information.

In one embodiment of the present disclosure, a system for electronically capturing, storing, and retrieving patient information and to provide remote access to the patient information over a computer network is provided. The system includes an evaluation device having a floor, a ceiling, and a plurality of walls that define an interior space, such as the range of motion measurement device 800. The evaluation devices includes at least one wall of the plurality of walls and the ceiling having multiple intersecting visible lines formed on a transparent portion thereof, the evaluation device further includes at least one movable opaque panel structured to be removably mountable on the floor and the plurality of walls.

The system also includes a data capture device that may be at least one from among a still camera and a video camera and structured to capture at least one image or at least one video image of a patient in the interior space of the evaluation device positioned behind the multiple intersecting visible lines and in front of the opaque movable panel. The system also includes a computing device having an input interface, a communication interface, and a non-transitory electronic storage medium coupled to the input interface and the communication interface, the input interface structure to receive the at least one image, the communication interface structure to receive patient identification information and patient evaluation and treatment information, and the non-transitory electronic storage medium structured to store the at least one image in association with patient identification information and to output the at least one image and the patient identification information to the computer network.

The system also includes patient clothing having multiple lines formed thereon and structured to be positioned over the patient's limbs and torso to enable measurement of patient movement on the at least one image or the at least one video image.

In another embodiment of the present disclosure, the system addresses a shoulder injury with the shoulder protocol. The shoulder protocol may also include range of motion testing. For example, the patient can move behind the transparent plates and face the camera. The horizontal axis of the upper front plate may be positioned level with the C7 spinous process. The top plate may be positioned with the horizontal axis across the shoulders. The patient should stand on the base with both feet positioned evenly on the horizontal axis. The examiner films the patient using a frontal camera angle to follow active range of motion movements, shoulder lateral abduction and adduction, and lateral neck bending. The examiner can also film the patient using an overhead camera angle to document shoulder internal and external rotation and neck rotation.

An additional view can be filmed with the affected side forward. The film may be taken from both sides if the injury is bilateral. Using the frontal camera angle, the examiner films active range of motion movements including shoulder forward and backward abduction and adduction. The examiner can position the patient with her back to the camera and film Appley's Scratch test maneuver and moving both hands up their back as far as they can go. The above sequence provides objective data of Shoulder Range of Motion from 3 dimensions.

Additional strength testing can be included in the shoulder protocol. The patient, positioned away from the plates, may be filmed from a front 45-degree camera angle, with the examiner out of the view of the shoulder. After positioning the dynamometer appropriately to the indicated anatomic areas, the examiner can film flexion (dynamometer placed in the antecubital fossa), extension (dynamometer placed over the distal post. humerus), internal rotation (dynamometer placed between the palmar wrists), external rotation (dynamometer placed on the back of the wrist), and an empty Can test (Jobes test) (no dynamometer). The examiner can also film, using a back 45 degree camera angle, a lift off test. This sequence provides visual and objective strength testing data.

Additional special test may include performing the following sequences using the front 45-degree camera angle with the examiner being careful to stay out of the way of the desired view: drop arm test, Neer's sign test, impingement tests, Hawkin's test, Speed's test, O'Brien's test, shoulder apprehension test, deep tendon reflexes, axial loading test, and Sperling's test.

The shoulder protocol can include performing standard sensory tests, which involve going over the relevant body areas using a variety of touch stimuli that includes, light touch (fingers going over the skin), cold (application of cold metal to skin), vibration (an activated tuning fork over the skin), and pinwheel (rolled over the skin). The examiner then records his findings using a digital highlighting marker over images of the patient facing front and back. One highlight color will be used to identify areas of decreased or altered sensation for each sensory modality using a standard color legend for each type of sensation. For example, yellow for diminished light touch, blue for decreased cold sensation, green for decreased vibration, red for decreased pinwheel sensation. The final image may then be incorporated into the system after the exam has been completed.

As described above, the system improves efficiency for patients, clinicians, health system managers, and third party payers. The standardized examination protocols and templates developed to address specific patient complaints reduce the chances of missing key data as a case is developed.

The highly objective video documentation of the patient examination allows reviewing clinicians to see the patient examination and glean valuable information that other clinicians might miss. The more eyes that review the examination, the less the chance of something being missed or overlooked.

The inclusion of links to imaging and EMR databases provides additional data in an integrated format, which further reduces the risk of missed data. The system has a feature that allows consultants to review the comments and recommendations of other clinicians. In doing so, consultants are exposed to the thoughts of other clinicians, which in turn can broaden or focus the clinical impressions more accurately, and again reduce the chances of error or misdiagnosis.

The system also encourages patient participation and involvement. The patient has opportunity to see his or her case, review the various comments and recommendations and actively participate in his/her case. This results in a more informed and involved patient, and again reduces the chances of error.

More particularly, during the initial examination protocol of a new examination compilation, the examiner creates a new system that will be available to the consulting clinicians via a secure web portal. The system provides the consulting clinicians with relevant data to be used in providing recommendations regarding the examination compilation. The consulting clinician can review the examination compilation on-line at any time after it has been posted and can record their observations and recommendations into the digital examination compilation presentation. The patient examination compilation can be reviewed in 15 minutes, which is significantly less time than needed for the clinician to evaluate the patient in person. This also reduces the costs incurred to evaluate the patient. In addition, the patient does not need to meet with each of the clinicians individually.

The system facilitates collecting and recording Patient Demographics, Past Medical History, Chief Complaint, History of Present Illness, height, weight, Facial Photograph, patient statement regarding goals, video exam sequences, including inspection plus thermal imaging, palpation, ROM, strength, sensation and reflexes, along with the specific sequences relevant to the chief complaint, links to Electronic Medical Records, links to Imaging Database, a Clinician comments button, and a billing button.

Using the system is of interest to health systems administrators because it allows a hospital or clinician group to expand their service area, attract patients to their treatment facilities, promote utilization of participating providers, create multiple revenue streams, and it is a powerful marketing tool. Additionally, it adds efficiency and increases clinical productivity.

Researchers can utilize in the database because of the built-in data mining features, standardization of examination methods, objective documentation format and ever growing size.

Health Care educators can utilize in the format because it provides a rich educational format that can be accessed by students seeking to gain knowledge regarding the evaluation and management of health issues. The patient examination compilation allow for exposure to a wide variety of cases and demonstrate various pathologies to students who might otherwise go years before seeing an example of certain variant conditions. The multidisciplinary consultation feature provides exposure to a variety of medical perspectives.

The system offers significant direct cost savings, which are realized when a full office visit consultation is avoided because the examination compilation is available via the system. The system saves time because the patient does not have to wait to attend a variety of consultation appointments and each clinician can view the examination compilation remotely on their own time. In addition, multiple consultations and opinions can be collected via the system simultaneously.

Advantageously, the system can increase quality by making multiple opinions available from multiple specialty clinicians, thus increasing the scope of evaluation and decreasing the likelihood of missed diagnosis. The system can also increase patient responsibility and autonomy and facilitate greater levels of involvement in their own health care. In the system, the patient has the option of selecting the clinicians that they would like to consult on their examination compilation. The patient can directly review the various opinions and recommendations collected in the system and make their own choices about how they would like to proceed. The patient can increase their understanding and knowledge of their condition by allowing them (or anyone else they so choose) to view their examination compilation in detail. In addition, the system allows third party payers to have a more complete and accurate assessment of the claimant's examination compilation.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
performing an examination protocol for a patient's condition structured for use in an asynchronous telemedicine environment, the performing including:
storing information about the patient's condition in an electronic examination storage medium;
providing remote access to the electronic examination storage medium over a computer network; and
transmitting notice of changes to the information over the computer network.

2. The method of claim 1 wherein the performing the examination protocol further comprises recording a series of patient movements using a physical structure having a plurality of reference points for visualizing outward indications of the patient's condition.

3. The method of claim 2 wherein the outward indications include one from among a range of motion, a reflex response, and a patient's strength.

4. The method of claim 2 wherein the recording includes audio, video, and written documentation of the patient movements.

5. The method of claim 1 wherein performing the examination protocol further includes preparing a patient medical history, recording the patient's vital signs, and recording information about the patient's condition.

6. The method of claim 1 wherein providing remote access includes providing remote access to a plurality of clinicians to enable collaborative analysis of the patient's condition in the asynchronous telemedicine environment.

7. The method of claim 6 wherein providing remote access includes providing remote access to a third party administrator and to the patient.

8. A method, comprising:
providing an asynchronous telemedicine environment for collaboratively diagnosing and treating a patient's condition;
providing an interface for clinicians to request an examination protocol to diagnose the patient's condition;
providing remote access over a computer network for the clinicians to review the examination protocol including reviewing audio, video, and written documentation of a series of patient movements stored in an electronic examination storage medium;
storing input from the clinicians in the electronic examination storage medium; and
transmitting notice of changes to the electronic examination storage medium.

9. The method of claim 8 further comprising providing the documentation of the series of patient movements by using a physical structure having a plurality of reference points for visualizing outward indications of the patient's condition.

10. The method of claim 8 wherein the input from the clinicians includes one from among a diagnosis, comments, recommendations, a treatment plan, and a request for an in-person consultation.

11. A system for electronically capturing, storing, and retrieving patient information and to provide remote access to the patient information over a computer network, comprising:
an evaluation device having a floor, a ceiling, and a plurality of walls that define an interior space, at least one wall of the plurality of walls and the ceiling having multiple intersecting visible lines formed on a transparent portion thereof, the evaluation device further including at least one movable opaque panel structured to be removably mountable on the floor and the plurality of walls;
a data capture device comprising at least one from among a still camera and a video camera and structured to capture at least one image or at least one video image of a patient in the interior space of the evaluation device positioned behind the multiple intersecting visible lines and in front of the opaque movable panel; and
a computing device having an input interface, a communication interface, and a non-transitory electronic storage medium coupled to the input interface and the communication interface, the input interface structure to receive the at least one image, the communication interface structure to receive patient identification information and patient evaluation and treatment information, and the non-transitory electronic storage medium structured to store the at least one image in association with patient identification information and to output the at least one image and the patient identification information to the computer network.

12. The system of claim 11, further comprising patient clothing having multiple lines formed thereon and structured to be positioned over the patient's limbs and torso to enable measurement of patient movement on the at least one image or the at least one video image.
